(19) United States
(12) Patent Application Publication
(10) Pub. No.: US 2016/0101505 A1
(43) Pub. Date: Apr. 14, 2016

(54) Ratchet Wrench

(71) Applicant: PARD HARDWARE INDUSTRIAL CO., LTD., Taichung City (TW)

(72) Inventor: Jian Liang Lin, TAICHUNG (TW)

(21) Appl. No.: 14/513,173

(22) Filed: Oct. 13, 2014

(51) Int. Cl. B25B 13/46

(52) U.S. Cl. CPC B25B 13/463

(57) ABSTRACT

A wrench includes a handle, a plate, a toothed wheel, a pawl, a switch and two detents. The handle includes a box end made with two spaces in communication with each other. The plate covers the spaces and includes two recesses in an upper side. The toothed wheel is inserted in the first space. The pawl is movable in the first space. The pawl includes a recess. The switch is inserted in the second space and includes a radial bore and a longitudinal bore. The first detent includes a portion inserted in the radial bore and another portion inserted in the recess of the pawl. The second detent includes a portion inserted in longitudinal bore and another portion for insertion in a selected one of the recesses of the plate.

### BACKGROUND OF INVENTION

1. Field of Invention

The present invention relates to a wrench and, more particularly, to a ratchet wrench.

2. Related Prior Art

A conventional wrench includes a box end and/or an open end for engagement with a nut or a head of a bolt.

A ratchet wrench includes a handle, a toothed wheel, a pawl, a switch and two spring-biased detents. The handle includes a box end. The toothed wheel is inserted in the box end of the handle. The toothed wheel is formed with teeth on the periphery and a square insert at the center. The pawl is also inserted in the box end of the handle. The pawl includes teeth for engagement with the teeth of the toothed wheel. The switch includes a lower portion rotationally inserted in the box end of the handle and an upper portion located out of the box end of the handle. The first spring-biased detent includes an end inserted in a radial bore in a side of the switch and an opposite end in contact with the pawl. The second spring-biased detent includes an end inserted in a bore in an internal side of the box end of the handle and an opposite end for insertion in a selected one of two radial recesses in an opposite side of the switch. Thus, the switch is kept in a selected one of two positions. Accordingly, the pawl is retained in a selected one of two positions. Hence, the box end of the handle is allowed to rotate the toothed wheel in one of two directions via the pawl. It is however difficult to make the bore in the internal side of the box end of the handle.

Therefore, the present invention is intended to obviate or at least alleviate the problems encountered in prior art.

### SUMMARY OF INVENTION

It is the primary objective of the present invention to provide an easily made wrench.

To achieve the foregoing objective, the wrench includes a handle, a plate, a toothed wheel, a pawl, a switch and two detents. The handle includes a box end formed with two spaces in communication with each other. The plate is attached to the handle to cover the spaces. The plate includes two recesses in an upper side. The toothed wheel is inserted in the first space. The pawl can be moved in the first space between two positions. The pawl can be engaged with the toothed wheel and jammed between the box end of the handle and the toothed wheel so that the toothed wheel can be rotated by the box end of the handle via the pawl. The pawl includes a recess. The switch is rotationally inserted in the second space and includes a radial bore and a longitudinal bore. The first detent includes a portion movably inserted in the radial bore and another portion inserted in the recess of the pawl. The second detent includes a portion movably inserted in longitudinal bore and another portion for insertion in a selected one of the recesses of the plate.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a wrench according to the preferred embodiment of the present invention;

FIG. 2 is a cross-sectional view of the wrench shown in FIG. 1;

FIG. 3 is another cross-sectional view of the wrench take along a line A-A shown in FIG. 2; and

FIG. 4 is another cross-sectional view of the wrench shown in FIG. 3.

### DETAILED DESCRIPTION OF PREFERRED EMBODIMENT

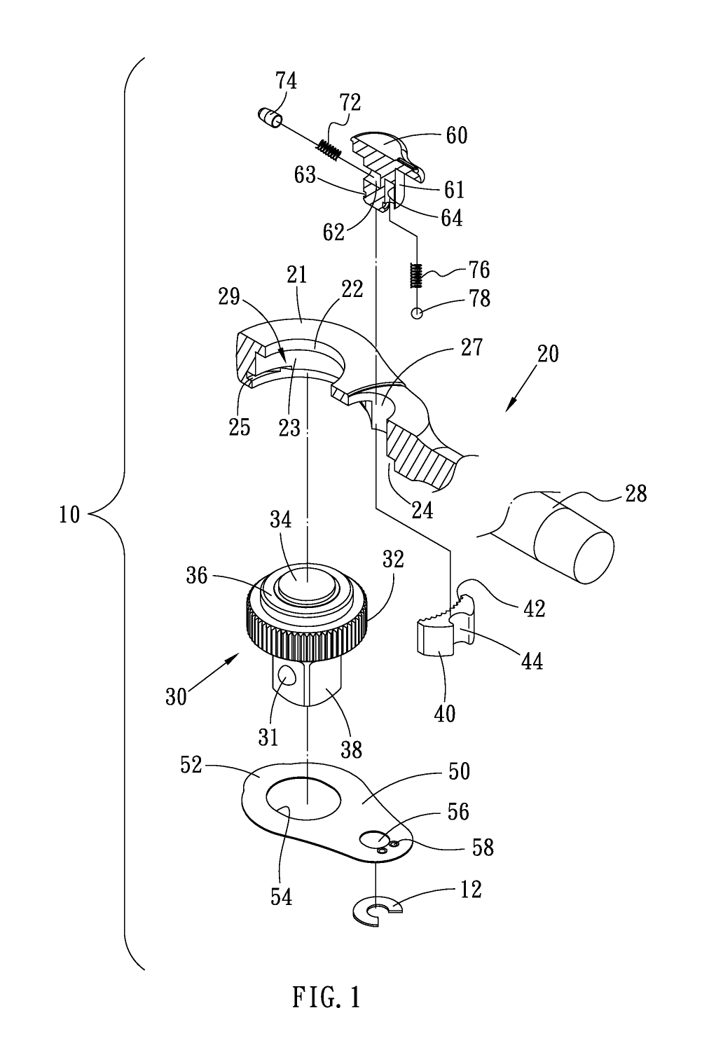

Referring to FIGS. 1 through 4, a wrench 10 includes a handle 20, a toothed wheel 30, a pawl 40, a plate 50, a switch 60 and two detents 74 and 78 according to the preferred embodiment of the present invention. The handle 20 includes a box end 21 and a grip 28 formed at an opposite end. The box end 21 includes two spaces 27 and 29 and a cavity 24. The space 27 is a circular one. The space 29 includes two openings 22 and 23. The first opening 22 is a circular one with a diameter larger than that of the space 27. The second opening 23 is a circular one with a diameter larger than that of the first opening 22. The second opening 23 is in communication with the space 27. The cavity 24 is in communication with the second opening 23 and the space 27. The box end 21 further includes a bore 25 in communication with the cavity 24.

The toothed wheel 30 includes teeth 32 formed on the periphery, an annular rib 36 formed on an upper side, and a square insert 38 extending from a lower side. The toothed wheel 30, which includes the square insert 38, is a hollow element. A button 34 includes a lower portion inserted in the toothed wheel 30 and an upper portion normally located out of the toothed wheel 30. A detent 31 includes a first portion inserted in the square insert 38 and a second portion located out of the square insert 38 when the first portion is pushed by the lower portion of the button 34 in a normal position. The second portion of the detent 31 is allowed to move into the square insert 38 when the first portion of the detent 31 is released from the lower portion of the button 34 in a pushed position.

The pawl 40 includes teeth 42 formed on a side and a recess 44 in an opposite side. The teeth 42 are made corresponding to the teeth 32 of the toothed wheel 30.

The plate 50 is shaped corresponding to the cavity 24. A tab 52 is formed on the plate 50. The tab 52 is made corresponding to the bore 25. The plate 50 includes two apertures 54 and 56. The plate 50 further includes two recesses 58 in an upper side.

The switch 60 includes a rod 61 formed beneath a lever (not numbered). The rod 61 extends perpendicular to the lever. A radial bore 62, a longitudinal bore 64 and an annular groove 63 are in the rod 61. The annular groove 63 is located lower than the radial bore 62 and the longitudinal bore 64.

The first detent 74 includes a rounded end and a recessed end. The first detent 74 is biased by a first spring 72. The second detent 78 is in the form of a ball. The second detent 78 is biased by a second spring 76.

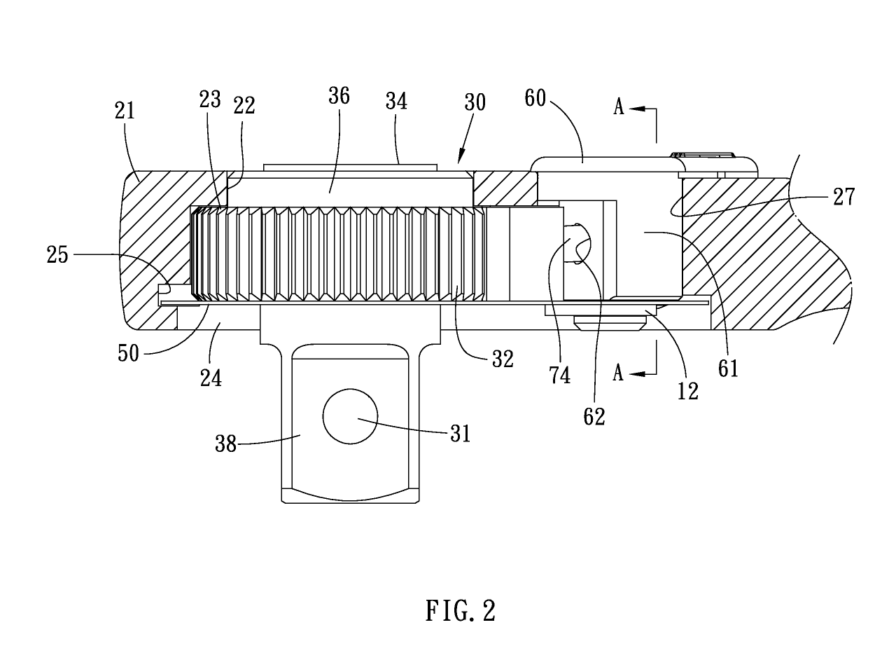

Referring to FIG. 2, the toothed wheel 30 is inserted in the second opening 23. The annular rib 36 is inserted in the first opening 22. The square insert 38 is located out of the box end 21.

The pawl 40 is inserted in the second opening 23. The teeth 42 are engaged with the teeth 32 of the toothed wheel 30.

The plate 50 is inserted in the cavity 24. The tab 52 is inserted in the bore 25. The square insert 38 extends through the aperture 54. The rod 61 extends through the aperture 56.

The rod 61 is inserted in the space 27. A C-clip 12 is inserted in the annular groove 63. The C-clip is located beneath the plate 50. Thus, the plate 50 is kept in the cavity 24.

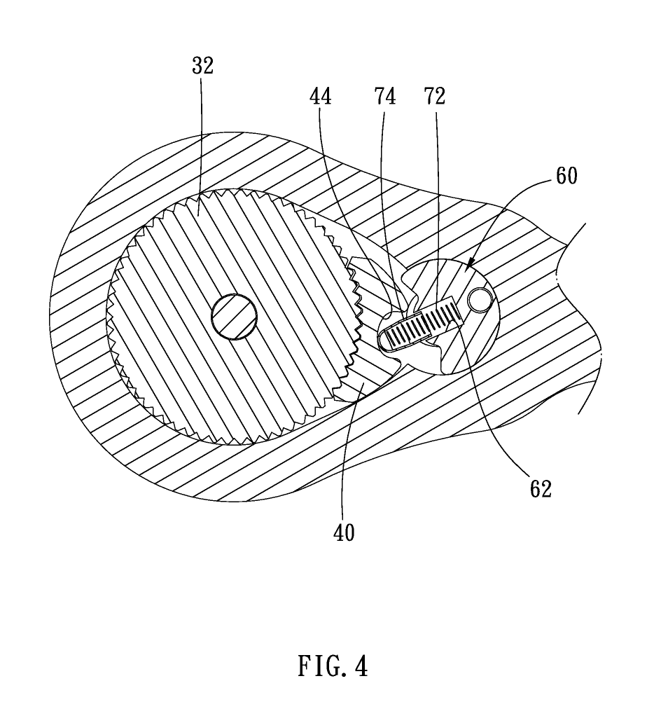

Referring to FIG. 4, an end of the first spring 72 is inserted in the radial bore 62. Another end of the first spring 72 is inserted in the recessed end of the first detent 74. The rounded end 74 of the first detent 74 is inserted in the recess 44.

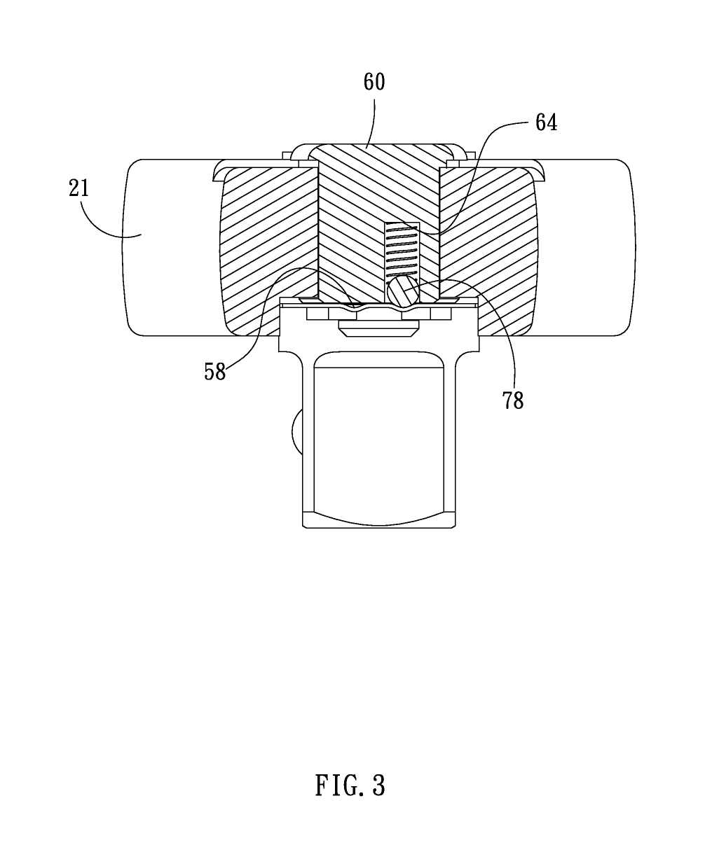

Referring to FIG. 3, an end of the second spring 76 is inserted in the longitudinal bore 64 while another end of the second spring 76 is in contact with a first portion of the second detent 78. A second portion of the second detent 78 is movable on the upper side of the plate 50. The second portion of the second detent 78 can be inserted in a selected one of the recesses 58.

Thus, the switch 60 is kept in a selected one of two positions. Hence, the pawl 40 is retained in a selected one of two positions. Accordingly, the box end 21 of the handle 20 is allowed to rotate the toothed wheel 30 in one of two directions via the pawl 40.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A wrench including:
a handle including a box end made with a first space and a second space in communication with the first space;
a plate attached to the handle to cover the first and second spaces, wherein the plate includes two recesses in an upper side;
a toothed wheel inserted in the first space;
a pawl movable in the first space between two positions, wherein the pawl can be engaged with the toothed wheel and jammed between the box end of the handle and the toothed wheel so that the toothed wheel can be rotated by the box end of the handle via the pawl, wherein the pawl includes a recess;
a switch rotationally inserted in the second space, wherein the switch includes a radial bore and a longitudinal bore;
a first detent including a portion inserted in the radial bore and another portion inserted in the recess of the pawl; and
a second detent including a portion inserted in longitudinal bore and another portion for insertion in a selected one of the recesses of the plate.

2. The wrench according to claim 1, further including a first spring formed with an end inserted in the radial bore and another end in contact with the first detent.

3. The wrench according to claim 2, further including a second spring formed with an end inserted in the longitudinal bore and another end in contact with the second detent.

4. The wrench according to claim 1, wherein the box end includes a bore in communication with the first space, and the plate includes a tab inserted in the bore of the box end.

5. The wrench according to claim 4, further including a C-clip, wherein the switch includes an annular groove for receiving the C-clip located beneath the plate.

6. The wrench according to claim 1, wherein the first detent includes a recessed end for receiving the spring and a rounded end inserted in the recess of the pawl.

7. The wrench according to claim 1, wherein the second detent is in the form of a ball.
